(19) United States
(12) Patent Application Publication
(10) Pub. No.: US 2005/0278739 A1
(43) Pub. Date: Dec. 15, 2005

(54) Video insertion when content is not available

(75) Inventors: Jeff Yaksick, Sunnyvale, CA (US); David Hendler Sloo, Menlo Park, CA (US); Elizabeth Rose McEnroe, Palo Alto, CA (US); Mike Cleron, Menlo Park, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 10/859,312

(22) Filed: Jun. 1, 2004

(51) Int. Cl. H04N 5/445; G06F 3/00; H04N 7/10

(52) U.S. Cl. 725/41; 725/39; 725/40

(57) ABSTRACT

Video insertion is described for unavailable content. In an implementation, a method includes determining whether a portion of each of a plurality of content items is available for output by a client and generating an EPG for output by the client. The EPG includes a plurality of cells, each of which describes a respective one of the content items. The EPG is configured based on the determining such that when the portion of the respective content item is available, the EPG includes the portion when output, and otherwise the EPG includes a video insertion when output that does not include the portion.

### TECHNICAL FIELD

The present invention generally relates to the field of content and more particularly relates to a video insertion when content is not available.

### BACKGROUND

Users have access to an ever increasing variety of content. For example, a user may view traditional television programming received over a network by using a client, such as a set-top box. The user may also view pay-per-view movies, order video-on-demand (VOD) content, and so on.

An electronic program guide (EPG) may be supplied to improve the user's experience with television programs. The EPG may enable the user to observe a listing of television programs that are currently being streamed, as well as a listing of television programs that will be streamed in the future. Additionally, the EPG may allow the user to navigate to a television program from the EPG itself. To provide additional information to the user, the EPG may describe the television programs using one or more television program characteristics, such as title, start time, channel, and so on.

A typical EPG, however, may provide this descriptive information in a fixed and unchanging manner that is inconsistent with the user's experience when viewing the television programs. A typical television program, for instance, is generally displayed such that it appears to have motion, such as in a situational comedy, a sporting event, televised news, and so on. The EPG, however, may be limited in the amount of motion that is included when displayed such that the display of the EPG interrupts the viewing experience. The EPG, for instance, may include channels which do not have corresponding previews of television programs on the channel. Therefore, the user is presented with a fixed display when navigating through such channels in the EPG, which diminishes the experience of the user with the EPG. For example, a user that navigates from a channel in the EPG that has motion to a channel which does not have motion may view this change as a client malfunction. Thus, the experience of viewing the EPG that does not have the characteristics associated with the content that is typically output by the client may result in the user's perception that the client and/or service is malfunctioning. This perception may diminish the viewing experience as well as result in expensive phone calls from the user to a customer support service of the content provider and/or client manufacturer.

Therefore, there is a continuing need for video insertion when content is not available.

### SUMMARY

Video insertion is described for unavailable content. A video insertion may be output for viewing by a user to give a viewing experience that is consistent with the content viewing experience. For example, a user may navigate between channels in an EPG that may or may not have available content for output, such as channels having content that is subject to a parental block, content that requires purchase before access is permitted, and so forth. One or more video insertions may be output in these situations in which content is unavailable such that the user is provided with a consistent viewing experience.

In an implementation, a method includes determining whether a portion of each of a plurality of content items is available for output by a client and generating an EPG for output by the client. The EPG includes a plurality of cells, each of which describes a respective one of the content items. The EPG is configured based on the determining such that when the portion of the respective content item is available, the EPG includes the portion when output, and otherwise the EPG includes a video insertion when output that does not include the portion.

### BRIEF DESCRIPTION OF THE DRAWINGS

FIG. 1 is an illustration of an environment in an exemplary implementation that includes a content provider that is communicatively coupled to a client over a network.

FIG. 2 is an illustration of an exemplary environment showing a distribution server and the client of FIG. 1 in greater detail.

FIG. 3 is an illustration of an exemplary implementation of a system showing the client and an EPG of FIG. 2 in greater detail

FIG. 4 is a flow chart depicting a procedure in an exemplary implementation in which a head end generates the EPG of FIG. 3 that, when output by the client, includes video insertions for when content is not available for output by the client.

FIG. 5 is a flow chart depicting a procedure in an exemplary implementation in which the client generates an EPG that, when output by the client, includes video insertions when content is not available for output by the client.

FIG. 6 is a flow chart depicting a procedure in an exemplary implementation in which a video insertion is utilized in a full screen display after a preview for a content item requiring purchase is displayed.

FIG. 7 is a flow chart depicting a procedure in an exemplary implementation in which a video insertion is utilized to fill a “gap” in a content viewing experience when content is not available for output by a client.

The same reference numbers are utilized in instances in the discussion to reference like structures and components.

### DETAILED DESCRIPTION

Overview

Video insertion is described for unavailable content. A video insertion may be output for viewing by a user to give a viewing experience that is consistent with the experience when viewing content that is not available for output. For example, when streaming content is unavailable when “tuning” to a channel, such as due to timing, purchase, or user-defined constraints, the video insertion is provided within the channel lineup such that the user is provided with a display having motion for each channel regardless of whether the channel has content that is available for output. The video insertion may be utilized in a full screen video presentation, a user-interface presentation incorporating a preview thumbnail video (PIP), such as in an electronic program guide (EPG), and so on.

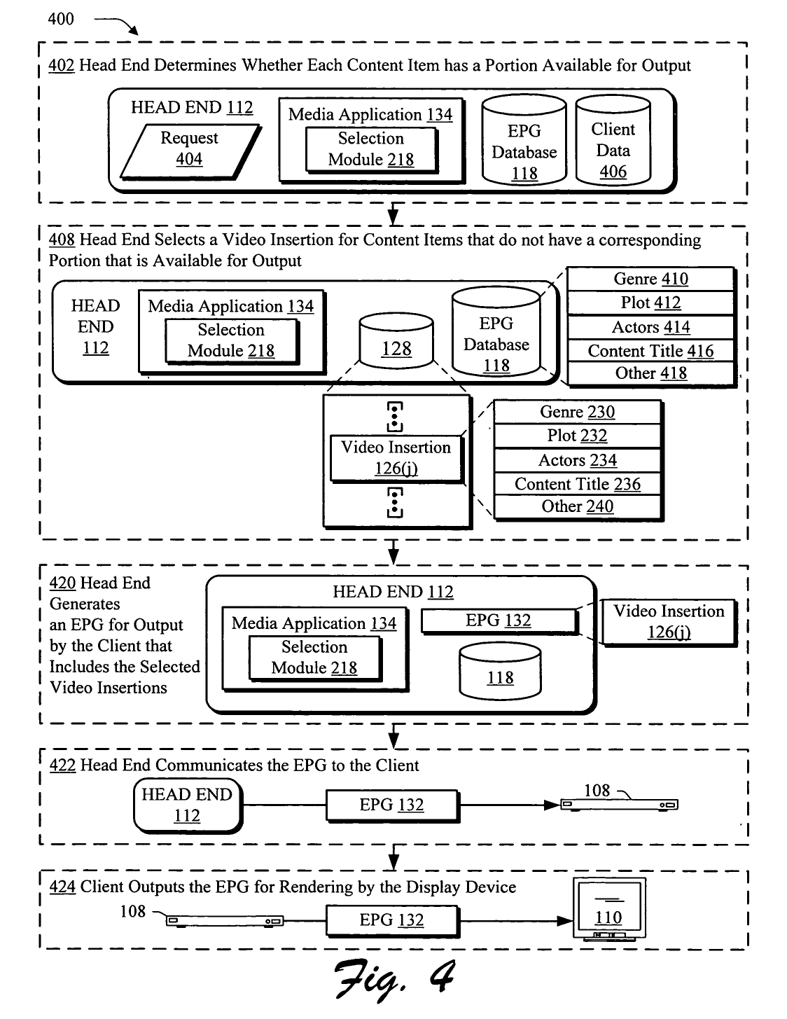

An EPG, for instance, may include a segment for displaying a portion of the content that is currently available on a chosen channel in the EPG. If the chosen channel does not have content which is available for output in the segment, the EPG may be output to include a video insertion that is selected to correspond to the content and/or causes for unavailability of the content. For example, a video insertion may be selected which has an actor that matches an actor in the content that is not available. In another instance, the video insertion may be selected because the content is unavailable due to a parental lock, and therefore a video showing a moving lock is output with the EPG. A video insertion may also be utilized in a variety of other ways, such as when “looking” forward in time within the EPG for a television program that is not yet available for broadcast; when a non-purchased Pay-Per-View (PPV) program has elapsed past a preview cycle; when a recorded television or Video On Demand (VOD) channel is in a non-play state; and so on. Further discussion of exemplary uses of video insertions may be found in relation to FIGS. 4-7.

Exemplary Environment

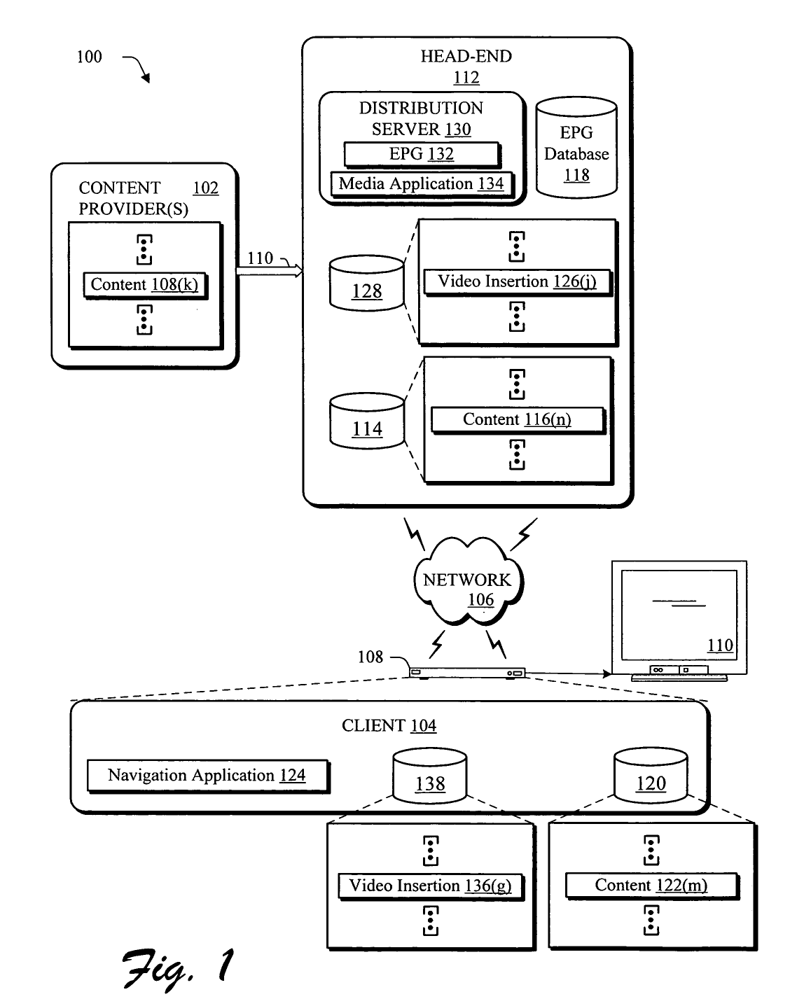

FIG. 1 is an illustration of an environment 100 in an exemplary implementation that includes a content provider 102 that is communicatively coupled to a client 104 over a network 106. The client 104 may be configured in a variety of ways. For example, the client 104 may be configured as a computer that is capable of communicating over the network 106, such as a desktop computer, a mobile station, an entertainment appliance, a set-top box 108 communicatively coupled to a display device 110 as illustrated, a wireless phone, and so forth. The client 104 may range from a full resource device with substantial memory and processor resources (e.g., television enabled personal computers, television recorders equipped with hard disk) to a low-resource device with limited memory and/or processing resources (e.g., traditional set-top boxes). The client 104 may also relate to a person and/or entity that operates the client. In other words, client 104 may describe a logical client that includes a user and/or a machine. Although one client 104 is illustrated, a plurality of clients may be communicatively coupled to the network 106. The network 106 is illustrated as the Internet, and may include a variety of other networks, such as an intranet, a wired or wireless telephone network, a broadcast network which may include a backchannel to provide two-way communication, and so forth.

The content provider 102 includes a plurality of content 108(k), where “k” can be any integer from 1 to “K”. The content 108(k) may include a variety of data, such as streaming content (e.g., television programming and pay-per-view movies), one or more results of remote application processing, and so on. The content 108(k) is communicated over a network 110 to a head end 112. The network 110 may be the same as or different from network 106. For example, the network 110 may be configured as a private subnet while the network 106 is configured as the Internet.

Content 108(k) communicated from the content provider 102 over the network 110 is received by the head end 112 and stored in a storage device 114 as content 116(n), where “n” can be any integer from “1” to “N”. The content 116(n) may be the same as or different from the content 108(k) received from the content provider 102. The content 116(n), for instance, may include additional data for streaming to the client 104, may be compressed using one or more data compression techniques by the head end 112, and so forth.

The head end 112 may also include electronic program guide (EPG) data that is stored in an EPG database 118 for communication to the client 104. In an implementation, the EPG data is broadcast utilizing a carousel file system. The carousel file system repeatedly broadcasts the EPG data over an out-of-band (OOB) channel to the client 104 over the network 106. In another implementation, an EPG is formed from the EPG data and then distributed to the client 104. Distribution from the head end 112 to the client 104 may be accommodated in a number of ways, including cable, RF, microwave, digital subscriber line (DSL), and satellite.

The client 104 may be configured in a variety of ways to receive the content 116(n) over the network 106. As illustrated, the client 104 may be configured as a set-top box 108 that is communicatively coupled to a display device 110. The client 104 includes hardware and software to transport and decrypt content 116(n) received from the head end 112 for rendering by the display device 110. Although a display device 110 is shown, a variety of other output devices are also contemplated, such as speakers.

The client 104 may also include digital video recorder (DVR) functionality. For instance, the client 104 may include a storage device 120 to record content 116(n) received from the network 106 for output to and rendering by the display device 110. The storage device 120 may be configured in a variety of ways, such as a hard disk drive, a removable computer-readable medium (e.g., a writable digital video disc), and so on. Content 122(m), where “m” can be any number from “1” to “M”, that is stored in the storage device 120 of the client 104 may be copies of the content 116(n) that was streamed from the head end 112. Additionally, content 122(m) may be obtained from a variety of other sources, such as from a computer-readable medium that is accessible by the client 104.

The client 104 includes a navigation application 124 that is executable on the client 104 to control content playback on the client 104, such as through the use of one or more “trick modes”. The trick modes may provide non-linear playback of the content 122(m) (i.e., time shift the playback of the content 122(m)) such as pause, rewind, fast forward, slow motion playback, and the like. For example, during a pause, the client 104 may continue to record the content 116(n) in the storage device 120 as content 122(m). The client 104, through execution of the navigation application 124, may then playback the content 122(m) from the storage device 120, starting at the point in time the content 122(m) was paused, while continuing to record the currently-broadcast content 116(n) in the storage device 120 from the head end 112.

When playback of the content 122(m) is requested, the navigation application 124 may be executed on the client 104 to retrieve the content 122(m). The navigation application 124 may also restore the content 122(m) to the original encoded format as received from the content provider 102. For example, when the content 122(m) is recorded on the storage device 120, the content 122(m) may be compressed. Therefore, when the navigation application 124 retrieves the content 122(m), the content 122(m) is decompressed for rendering by the display device 110.

The head end 112 includes a storage device 128 for storing a plurality of video insertions 1260), where “j” can be any integer from 1 to “J”. Although illustrated separately, the storage device 128 may be the same as or different from the storage device 114 that is used to store the content 116(n). The head end 112 also includes a distribution server 130. The distribution server 130 provides for distribution of the content 116(n), EPG data from the EPG database 118, and/or video insertions 1260) over the network 106 to the client 104.

The video insertions 126(j) may be utilized in a variety of ways, such as for inclusion in an EPG 132, for output in conjunction with a function for obtaining conditional access rights to the content by the client 104, and so on. For example, the distribution server 130 may generate an EPG 132 that describes content 116(n) available for output by the client 104. The distribution server 130 executes a media application 134 to generate the EPG 132 and selects one or more of the video insertions 126(j) for inclusion in the EPG 132. The media application 134, for instance, may select one or more of the video insertions 126(j) for output in conjunction with descriptions of content in the EPG 132 for content that is not available to the client 104, such as due to parental locks, failure to obtain conditional access rights to the content by the client 104, and so on. The EPG 132 and the selected video insertions 126(j) may then be communicated to the client 104 over the network 106 for output by the client 104 and rendering by the display device 110. The video insertions 126(j) provide video for inclusion in the EPG 132 such that a viewer of the EPG 132, when rendered, is provided with a consistent viewing experience that displays generally consistent motion.

Video insertions 126(j) may also be stored on the client 104 as a plurality of video insertions 136(g), where “g” can be any integer from one to “G”, on a local storage device 138. The plurality of video insertions 136(g) may be the same as or different from video insertions 126(j). For example, video insertions 136(g) may be locally stored versions of the plurality of video insertions 126(j) that were communicated over the network 106. In another example, video insertions 136(g) are provided by accessing a computer-readable medium by the client 104. In a further example, the client 104 might also reside within the head end 112. In such an environment, the distribution server 130 can transmit content 116(n) via the network 106 to node video display that does not perform content-related processing other than display of the content 116(n). The distribution server 130, for instance, may decide, through execution of the media application 134, that when content 116(n) is not available for a particular channel, that one or more of the video insertions 126(j) are to be transmitted over the network 106. Further discussion of selection of the video insertions 126(j), 136(g) may be found in relation to FIGS. 4, 5 and 7.

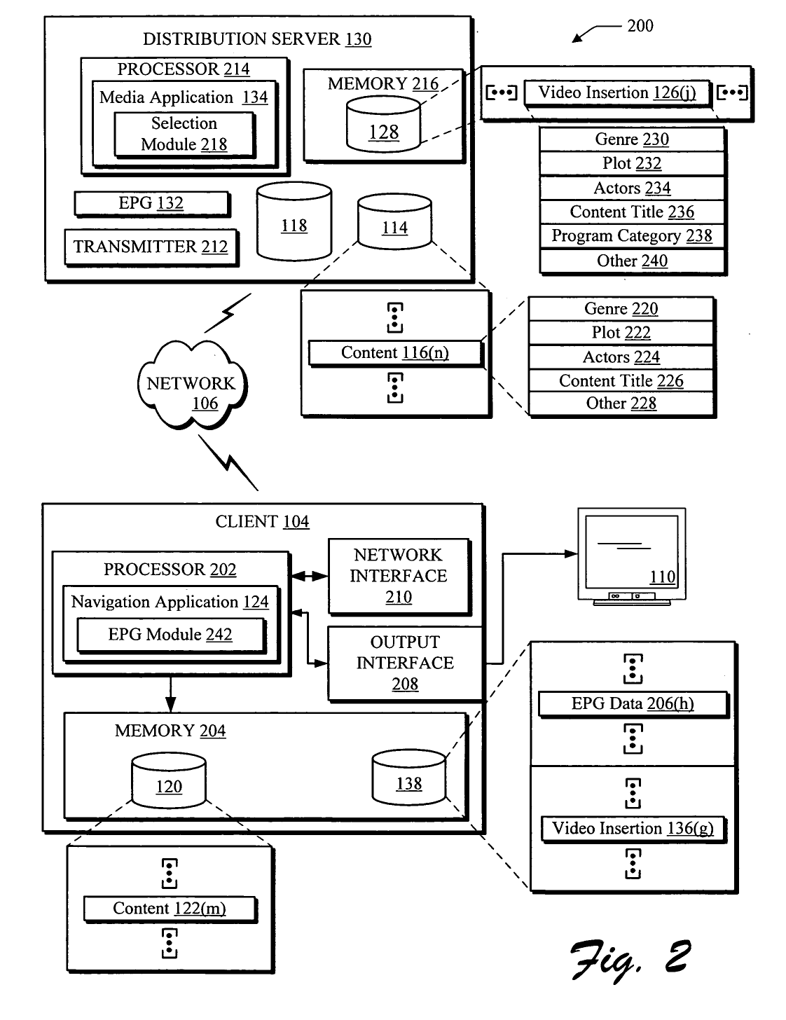

FIG. 2 is an illustration of a system 200 showing exemplary implementations of the distribution server 130 and the client 104 of FIG. 1 in greater detail. The client 104 includes a processor 202 and memory 204. The navigation application 124 is illustrated as being executed on the processor 202 and is storable in memory 204. The storage device 120, which is utilized to store the plurality of content 122(m), is illustrated as included in the memory 204. Likewise, the storage device 138, which is utilized to store the plurality of video insertions 130(g), is also illustrated as included in the memory 204. The storage device 138 may also be utilized to store a plurality of EPG data 206(h), where “h” can be any integer from one to “H”. For example, the EPG data 206(h) may be copies of EPG data stored in the EPG database 118 on the distribution server 130. Although illustrated together, the memory 204 may be different from either one or both of the storage devices 120, 128. For example, the storage devices 120, 138 may be implemented as a hard disk drive and the memory 204 may be configured as RAM, both the memory 204 and the storage device 120 may be configured as RAM and the storage device 138 may be configured as a removable memory device, and so forth.

The client 104 may obtain content from a variety of sources. For example, the client 104 may execute the navigation application 124 to retrieve content 122(m) from the storage device 120. The retrieved content 122(m) may then be output using an output interface 208 for rendering on the display device 110. The client 104, through execution of the navigation application 124, is also capable of requesting content 116(n) from the distribution server 130 over the network 106. The distribution server 130 is represented pictorially as including the storage device 114 having the plurality of content 116(n) for streaming over a network 106. In another implementation, the distribution server 130 may provide EPG data from the EPG database 118 that describes content available from other content providers.

The navigation application 124, when executed on the processor 202, may send a request via the network 106 to the distribution server 130 to request content 116(n) for streaming over the network 106, such as a PPV movie, VOD, and so forth. The client 104 includes a network interface 210 to communicatively couple the client 104 with the distribution server 130. As previously described, the network 106 may support two-way communication between the distribution server 130 and the client 104. Additionally, the network 106 can be any type of network, using any type of network topology and any network communication protocol, and can be represented or otherwise implemented as a combination of two or more networks including, for example, microwave, satellite, and/or data networks, such as the Internet. Furthermore, the network 106 may be capable of transmitting and receiving wired or wireless media using any broadcast format or broadcast protocol.

The distribution server 130 also includes a transmitter 212. The transmitter 212 provides distribution of the content 116(n) of FIG. 1 from the storage device 114 and EPG data from the EPG database 118 across the network 106 to the client 104. In alternate implementations, the distribution server 130, storage device 114, and transmitter 212 may be implemented as one or more distinct components, locally as part of the head end 112 and/or content provider 102 of FIG. 1, or remotely as part of another distinct system.

The distribution server 130 includes a processor 214, memory 216, and the media application 134, which is illustrated as being executed on the processor 214 and is storable in memory 216. The media application 134, when executed, controls distribution of the data from the EPG database 118 over the network. The media application 134 may also control distribution of the content 116(n) over the network 106. For instance, the media application 134 may receive a request from the client 104 to receive the content 116(n). The media application 134 processes the request, such as to determine whether the client 104 is permitted to receive the content 116(n) (e.g., the client 104 has obtained conditional access rights to the content), obtain billing information from the client 104, locate the requested content from the plurality of content 116(n), and so on. If the client 104 is permitted to receive the content 116(n), the media application 134 may be executed to stream the content 116(n) to the client 104 over the network 106.

The navigation application 124 may also communicate with the media application 134 to provide trick modes (e.g., non-linear playback, such as time shifting) for the playback of the content 116(n). For example, the client 104 may communicate with the distribution server 130 through execution of the respective navigation and media applications 128, 134 over the network 106 to pause, fast forward, rewind, playback in “slow motion,” and so forth. In this instance, however, the client 104, through execution of the navigation application 124, controls the distribution server 130 to regulate content 116(n) playback through the use of commands that are communicated over the network 106, instead of locally with the storage device 120 of the client 104 as previously described.

In a further implementation, the client 104 may execute the navigation application 124 to cause recordation of the content 116(n) at the distribution server 130. For example, the navigation application 124 may form a request that is communicated to the distribution server 130 over the network 106 to record content 108(k) of FIG. 1 communicated to the distribution server 130 from the content provider 102. The media application 134, in response to the request, is executed to record the requested content such that the media application 134 operates as a network digital video recorder (NDVR). Thus, through execution of the navigation application 124, the client 104 may playback locally-stored content 122(m), content 116(n) that is stored remotely over the network 106, and may even control the recordation and playback of the remotely stored content 116(n) to the client 104.

As previously described, the video insertions 126(j ), 136(g), may be utilized to provide a consistent viewing experience. For example, the distribution server 130 may execute a selection module 218 to select one or more of the video insertions 126(j) stored in the storage device 128 for communication to the client 104. The video insertions 126(j), for instance, may be included in the EPG 132 generated by the media application 134 such that when the EPG 132 is rendered the viewer is provided with a consistent viewing experience. Although the selection module 218 is illustrated as software that is included as a part of the media application 134, the selection module 218 may be implemented separately as “stand alone” software.

The video insertions 126(j) may be selected through execution of the selection module 218 on the processor 214 in a variety of ways. For example, the selection module 218, when executed, may select one or more of the video insertions 126(j) based on characteristic of the content 116(n) that is not available. For instance, a request for streaming of stored content 116(n) may include metadata that describes the content 116(n). Examples of metadata include genre 220, plot 222 (e.g., detailed textual description of the plot of the corresponding content 116(n)), actors 224 included in the content 122(m), content title 226, and other 228 descriptive data. For example, the other 228 descriptive data may describe a content category (e.g., PPV movie, VOD), identify a content owner (e.g., production company), and so on.

The selection module 218, when executed, may then compare the metadata with data used to identify the video insertions 126(j). For example, each of the plurality of video insertions 126(j) may include data that corresponds to the metadata of the content 116(n), such as genre 230, plot 232, actors 234, content title 236, program category 238, and other 240 descriptive data. The selection module 218, when executed, may then match the metadata of the content 116(n) with the data of the video insertions 126(j) to find a match, thereby selecting one or more of the video insertions 126(j). The selected video insertions 126(j) may then be communicated to the client 104 over the network 106 for output by the client 104. In another implementation, the advertisements 126(j) may also be selected using EPG data from the EPG database 118. For example, the request from the client 104 may include the content title 226. The selection module 218, when executed, may utilize the content title 226 to find additional metadata that describes the content 116(n) from the EPG database 118. Therefore, the selection module 218 may then utilize the data obtained from the EPG database 118 to select one or more of the video insertions 126(j).

The client 104 may also be configured to supply video insertions 136(g) stored locally on the client 104. For example, the EPG 132 generated by media application 134 may reference video insertions to be included when output, but may not contain the actual video insertion. The client 104, when processing the EPG 134 for output to and rendering by the display device 110, acquires video insertions 136(g) referenced by the EPG 134 for inclusion in the EPG 134 when output. In another example, the navigation application 124 includes an EPG module 242 that, when executed, generates an EPG locally on the client 104 from EPG data that was streamed from the EPG database 118 on the distribution server 130. Thus, video insertions 126(j), 136(g) may be utilized in an EPG that is generated at the distribution server 130 or at the client 104.

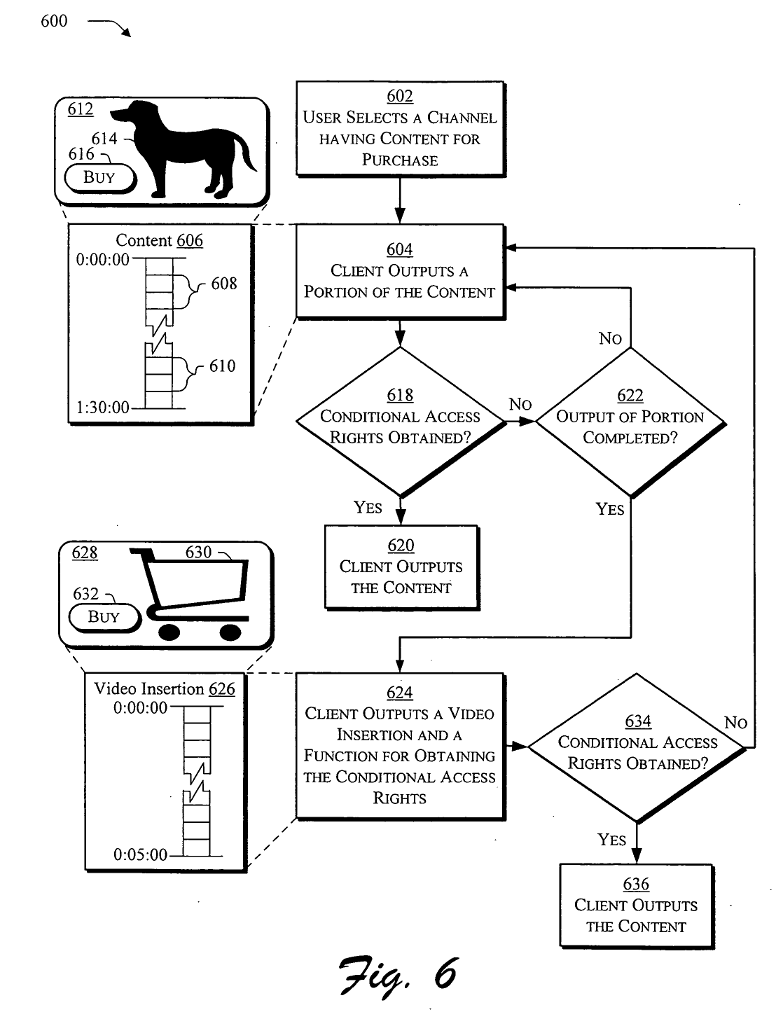

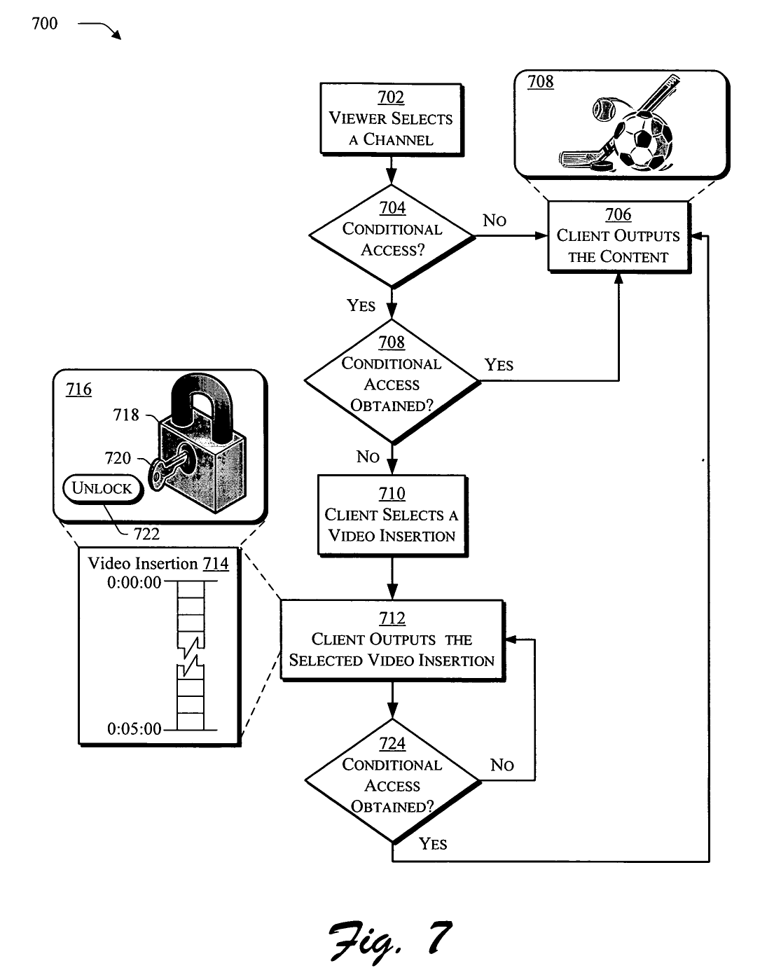

The video insertions 126(j), 136(g) may also be utilized in other instances in which a consistent viewing experience is desired when content is not available. For example, content may be unavailable for output because the content has conditional access rights, such as content that requires payment (e.g., PPV movies, television programming subscriptions, and so on), parental blocks employed to limit access to the content, and so forth. Further discussion of the use of video insertions for conditional access rights related to content purchasing may be found in relation to FIG. 6. Additionally, further discussion of the use of video insertions for conditional access rights relating to parental blocks may be found in relation to FIG. 7.

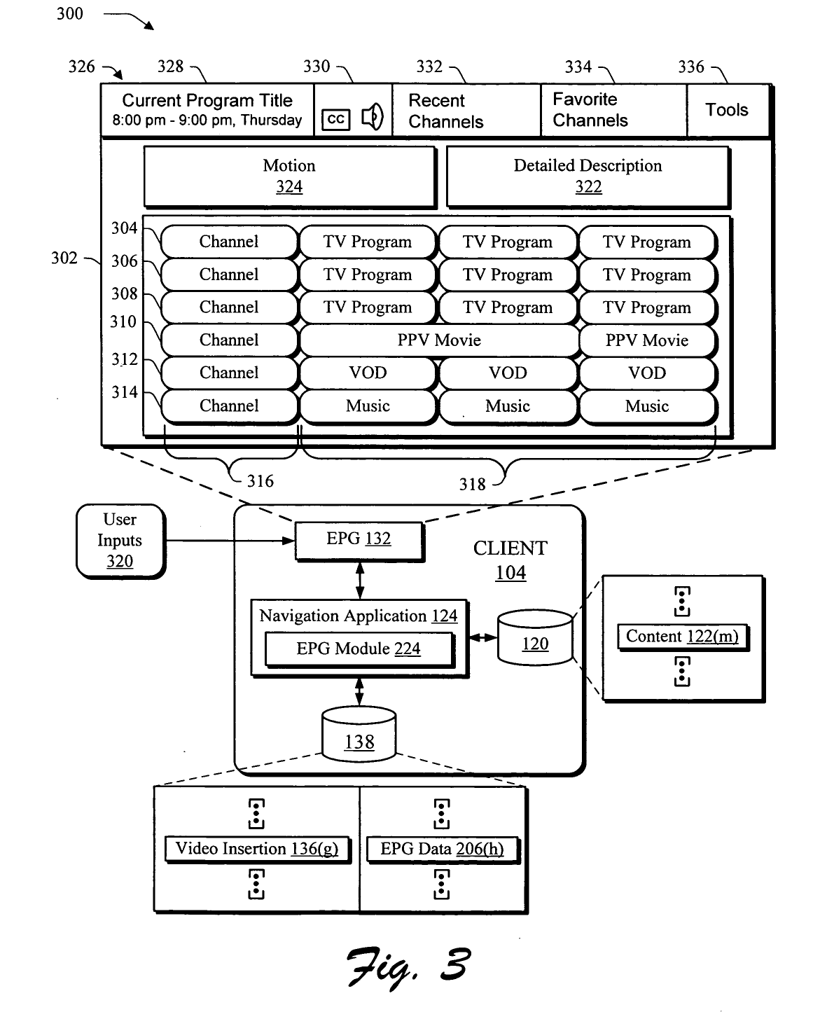

FIG. 3 is an illustration of an exemplary implementation of a system 300 showing the client 104 and the EPG 132 of FIG. 2 in greater detail. A display 302 of the EPG 132 is illustrated such as it may appear when rendered by the display device 110 of FIG. 2. The EPG 132 is organized to describe content available for streaming on a plurality of channels 304-314. Additionally, each of the plurality of channels 304-314 is illustrated as including a respective cell in a channel segment 316 of the EPG 132 that describes the respective channel.

Each of the plurality of channels 304-314 is also illustrated as including a plurality of cells shown in a content segment 318 of the EPG 312 that describes content that is available from the respective channels 304-314. For example, channels 304-308 are illustrated as including cells which describe television programs, channel 310 is illustrate as including cells which describe PPV movies, channel 312 is illustrated as including cells which describe VOD, and channel 314 is illustrated as including cells which describe music that is available for streaming to the client 104.

Each of the cells in the content segment 318 of the EPG 132 may describe respective content in a variety of ways, such as describing characteristics that include genre, content title, one or more actors in the content, author of the content, program category (e.g., VOD, PPV, TV program, etc.), content owner (e.g., a company that created the content), a title, a duration, a start time, a stop time, an elapsed time in the streaming of the content, a time remaining in the streaming of the content, a genre, a rating, a performer, a director, a story line, a description, a production credit, and so on. The cells may also include other data that describes respective content, such as a critic's opinion, a review, a recommendation, and so forth.

The EPG 132 may be configured in a variety of ways to provide functionality to a viewer of the EPG 132. For example, each of the cells in the channel and content segment 316, 318 may be chosen by a viewer using an input device, such as a remote control, to navigate to content described by that cell, record content described by that cell, and so on. When any particular one of the cells is chosen, additional descriptive information may be displayed in a detailed description 322 segment and a motion 324 segment. For example, when the viewer chooses a cell in the content segment 318 that corresponds to a particular content item, a detailed textual description of the particular content item is displayed in the detailed description 322 segment of the EPG 132.

Additionally, if a portion of the content is available for output in the EPG 132, that portion is displayed in the motion 324 segment of the EPG 132. The particular content item, for instance, may have a corresponding trailer which includes scenes taken from the particular content item. This trailer may be displayed in the motion 324 segment of the EPG 132 to provide a display of motion to a viewer of the display 302 of the EPG 132. If the portion of the particular content item is not available, however, the navigation application 124 may supply a video insertion 136(g) obtained from the storage device 138 and/or streamed from the storage device 128 of the head end 112 of FIG. 2. Therefore, even if the particular content item does not have a portion which is accessible by the client 104, a viewer of the display 302 of the EPG 132 may still be provided with an EPG viewing experience that is consistent with the content viewing experience. As previously described, output of a video insertion may be utilized in a variety of ways and is not limited to inclusion in an EPG, examples of which may be found in relation to FIGS. 6 and 7.

The EPG 132 is also illustrated as including a menu bar 326 to enable a user to navigate between functionality utilizing one or more of the input devices. The illustrated menu bar 326. has functionality including current program title 328, audio functionality 330 such as closed captioning and stereo, recent channels 332, favorite channels 334, and tools 336, such as options for arrangement, font selection, and so on.

As shown in FIG. 3, the EPG 132 may be configured to describe a variety of content. As illustrated, the EPG 132 describes content that is streamed to the client 104, such as television programs, PPV movies, VOD, ,and so on. The EPG 132 may also describe content 122(m) that is available locally on the client 104 on storage device 120, such as home movies, copies of content 116(n) of FIG. 2 that was streamed over the network 106, and so forth.

Exemplary Procedures

The following discussion describes video insertions that may be implemented utilizing the previously described systems and devices. Aspects of each of the procedures may be implemented in hardware, firmware, or software, or a combination thereof. The procedures are shown as a set of blocks that specify operations performed by one or more devices. The procedures are not necessarily limited to the orders shown for performing the operations by the respective blocks.

FIG. 4 is a flow chart depicting a procedure 400 in an exemplary implementation in which the head end 112 generates the EPG 132 that outputs video insertions 126(j) when content is not available for output by the client 104. At block 402, the head end 112 determines whether each of a plurality of content items has a portion that is available of output by the client 104, such as a trailer, a preview, or any other video that incorporates two or more frames of the content.

The head end 112, for instance, may receive a request 404 from the client 104 of FIG. 2 that requests an EPG. The request 404 may include a client identifier (ID) for identifying the client. The media application 134, when executed, compares the client ID from the request 404 with client data 406 that describes conditional access rights of the client to access content, such as content subscriptions, parental blocks, and so forth. Thus, the media application 134 may determine which content is available to that particular client. In this way, the head end 112 determines which content items are accessible to that particular client by determining the conditional access rights that were obtained by the particular client. Additionally, the head end 112 may also determine if those content items are reachable by the client, such as over the network 106 of FIG. 1. For example, the media application 134, when executed, may also determine other availability aspects, such as it the content provider which provides the content is functioning properly and therefore the content is available to the client. The head end 112 may select two or more frames of the content for inclusion in the EPG when output by the client. Portions of content may be obtained in a variety of other ways. For example, the media application 134 may locate a pre-configured trailer or preview of the corresponding content item that matches a title of the content item.

At block 408, the head end 112 selects a video insertion for content items that do not have a corresponding portion that is available for output by the client. The media application 134, for instance, may include a selection module 218 that, when executed, may select a video insertion from the plurality of video insertions 126(j) based on a variety of factors, such as causes for unavailability of the content, characteristics of the content, and so forth. For example, the selection mode 218 may examine EPG data 118 that describes the unavailable content item. The unavailable content item may be described in the EPG database 118 by using one or more of a variety of characteristics, such as by genre 410, plot 412, actors 414, content title 416, and other 418 descriptive data. The selection module 218, using the characteristics found from the EPG database 118, selects one or more of the plurality of video insertions 126(j) that have corresponding characteristics, such as genre 230, plot 232, actors 234, content title 236, and other 240 characteristics as previously described. For example, the EPG data 118 may indicate that a particular actor is included in the unavailable content item. The selection module 218, when executed, locates a video insertion 126(j) that includes that particular actor. In this way, the video insertion 126(j) may be selected that is “relevant” to the unavailable content item.

At block 420, the head end generates the EPG 132 for output by the client that includes the selected video insertions. The EPG 132, for example, may be generated from EPG data obtained from the EPG database 118. The EPG 132 may also be configured to include the video insertion 126(j) selected at block 408. For example, the media application 134 may insert the video insertion 126(j) into the EPG 132. In another example, the media application 134 may insert a tag in the EPG that indicates where to obtain the video insertion 126(j).

At block 422, the head end 112 communicates the EPG 132 to the client which is represented pictorially as a set-top box 108. The EPG may be communicated in a variety of ways. The head end 112, for instance, may stream the EPG 132 to the client, broadcast the EPG using a carousel file system, and so on. At block 424, the client outputs the EPG 132 for rendering by the display device 110. For example, the EPG 132 may be configured to include the video insertion 126(j) by the head end 112 such that when the EPG 132 is output the video insertion is rendered by the display device 110. In another example, the EPG 132 may include tags that describe where the client can obtain the video insertion. Therefore, the client obtains the video insertion for output in the EPG 132. Although in this implementation the head end 112 was described as generating the EPG 132, the EPG 134 may also be generated by the client, further discussion of which may be found in relation to the following implementation

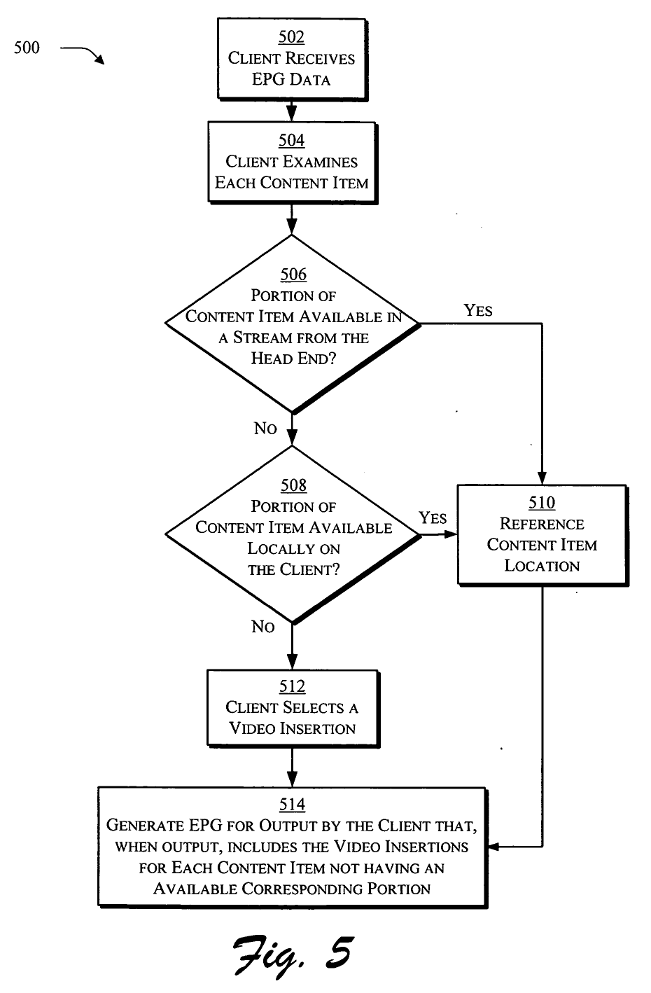

FIG. 5 is a flow chart depicting a procedure 500 in an exemplary implementation in which the client 104 of FIG. 2 generates an EPG that, when output by the client, includes video insertions when content is not available for output by the client. At block 502, the client receives EPG data. For example, the EPG data may be broadcast by the head end 112 of FIG. 1 using a carousel file system.

At block 504, the client examines each content item that is described in the EPG data, such as television programs, VOD, PPV movies, and so on. At decision block 506, a determination is made as to whether a portion of each content item described in the EPG data is available in a stream from the head end. For example, the client may determine which, if any, of the content items have a preconfigured portion that is available from the head end, such as a preview, a trailer, and so on. For content items that do not have corresponding preconfigured portions, the client may then determine if each content item is currently being broadcast, whether the client has obtained conditional access rights to access the content item, and so forth. The client, for instance, may determine that a content item is a PPV movie that has not been purchased by the client and is therefore not available to the client at this time. At decision block 508, the client also determines whether a portion of the content item is available locally on the client. For example, the client may have a locally accessible movie trailer that was copied to the client from a computer-readable medium, such as a digital video disc (DVD). The client may also include copies of the content item, such as a television program recorded by the client when configured as a DVR. If the portion of the content item is available from the head end (block 506) or available locally on the client (block 508), the location of the content item is referenced for inclusion in an EPG (block 510).

If the portion of the content item is not available from the head end (block 506) or available locally on the client (block 508), the client selects a video insertion (block 512). As previously described, the video insertion may be selected in a variety of ways, such as due to causes for content unavailability (e.g., device, network, or software malfunction), characteristics of the unavailable content, and so forth. At block 514, the EPG is generated for output by the client that, when output, includes the video insertions for content items that do not have an available corresponding portion. Although the previous implementations described in relation to FIGS. 4 and 5 described inclusion of video insertions in an EPG, video insertions may be utilized in a variety of ways, examples of which are discussed in greater detail in the following procedures.

FIG. 6 is a flow chart depicting a procedure 600 in an exemplary implementation in which a video insertion is utilized in a full screen display after a preview for a content item requiring purchase is displayed. Video insertions may be utilized in a variety of ways to supply a consistent viewing experience. At block 602, for instance, a user interacts with a client, such as a set-top box, to select a channel having content that is available for purchase. At block 604, the client outputs a portion of the content 606. The content 606, for example, may include a plurality of frames which is represented pictorially in FIG. 6 as a plurality of blocks in a timeline. A preview may be configured that includes a portion 608 of the content 606, e.g. two or more frames, so that a user may decide whether to purchase the content 606 by viewing the portion 606. Multiple portions 608, 610 may also be taken from the content 606 for display of potential points of interest in the content 606 to encourage the purchase of the content 606, such as action scenes, and so forth. When the portion 608 is displayed (which is represented pictorially by block 612 in FIG. 6), the portion 608 may include an image 614 taken from the content 606 as well as a display of a finction 616 of a user-interface to enable the user to purchase the content 606, such as to purchase the content using the client, instructions on how to telephone a content provider to purchase the content, and so on.

At decision block 618, a determination is made as to whether conditional access rights to the content 606 have been obtained, such as whether the user has purchased the content 606 by providing payment information. If the conditional access rights have been obtained (block 618), the client outputs the content for viewing by the user (block 620). If the conditional access rights have not been obtained (block 618), the procedure 600 proceeds to decision block 622 at which a determination is made as to whether output of the portion is completed. If not, the procedure 600 loops back to block 604 for continued output of the portion 608.

If output of the portion 608 is completed (block 622), then at block 624 the client outputs a video insertion 626 and a function 632 for obtaining the conditional access rights. The video insertion 626, for instance, may include a plurality of frames which are represented pictorially as blocks in a timeline. When the video insertion 626 is displayed (which is represented pictorially by block 628 in FIG. 6), the video insertion 626 may include an image 630 and a display of a function 632 of a user-interface to enable the user to purchase the content 606. Thus the video insertion 626 supplies an output of video for when the portion 608 of the content 606 is no longer output, thereby providing a consistent viewing experience. At decision block 634, like decision block 618, a determination is made as to whether conditional access rights to the content 606 have been obtained. If the conditional access rights have been obtained (block 634), the client outputs the content for viewing by the user (block 636). If the conditional access rights have not been obtained (block 634), the procedure 600 loops back to block 604, at which, the client again outputs the portion 608 of the content 606. Thus, in this exemplary implementation the video insertion is utilized to provide video after viewing a preview of content that is available for purchase

FIG. 7 is a flow chart depicting a procedure 700 in an exemplary implementation in which a video insertion is utilized to fill a “gap” in a content viewing experience in which content is not available for output by a client. A user, for instance, by selecting a channel for viewing (block 702) may “channel surf” through a variety of channels that are streamed by content providers to locate a particular content item of interest. At decision block 704, the client makes a determination as to whether access to the content on the selected channel is controlled through conditional access rights. For example, access to the content of the selected channel may be restricted by a parental block. If the content is not subject to conditional access (block 704), the client outputs the content (block 706).

If the content is subject to conditional access rights (block 704), a determination is made as to whether conditional access rights have been obtained by the client (decision block 708). For example, the user may enter an access code to remove the parental block, after which the client outputs the content (block 706). If conditional access has not been obtained, then the client selects a video insertion (block 712) which is output by the client (block 714). As previously described, the video insertion 716 may be selected in a variety of ways, such as selected due to the cause of the unavailability of the content, one or more characteristics of the content, and so forth. For example, the video insertion 716 in this instance is selected based on the cause of the unavailability of the content, i.e. the parental block. Therefore, the video insertion 716, when rendered (which is represented pictorially by block 718), includes a display of a lock 720 and a rotating key 722. The video insertion 716 also includes a display of a f unction 724 of a user interface for obtaining the conditional access right to access the content, which in this example is to unlock the content. At decision block 726, a determination is made as to whether the conditional access has been obtained. If so, the client outputs the content (block 706). If not, the client continues to output the selected video insertion (block 714). Thus, in this implementation when the conditional access right for access the content has not been obtained by the client, the portion of the content is output, followed by a video insertion to provide the user with a consistent display of motion.

Conclusion

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method comprising:
determining whether a portion of each of a plurality of content items is available for output by a client; and
generating an EPG for output by the client, wherein:
the EPG includes a plurality of cells;
each said cell describes a respective said content item; and
the EPG is configured based on the determining such that when the portion of the respective said content item is available, the EPG includes the portion when output, and otherwise the EPG includes a video insertion when output that does not include the portion.

2. A method as recited in claim 1, wherein the determining and the generating are performed by a head end.

3. A method as recited in claim 1, wherein the determining and the generating are performed by the client.

4. A method as recited in claim 1, wherein the portion of the respective said content item is available when a conditional access right to a corresponding said content item has been obtained by the client.

5. A method as recited in claim 1, wherein the portion of the respective said content item is selected from the group consisting of:
a trailer;
a preview;
two or more frames of the respective said content item that have been edited; and
any combination of the foregoing.

6. A method as recited in claim 1, wherein at least one said content item is a television program.

7. A method as recited in claim 1, further comprising selecting the video insertion based on one or more causes for the unavailability of the portion.

8. A method as recited in claim 1, wherein the one or more causes for the unavailability of the portion are selected from the group consisting of:
parental lock;
software malfunction;
hardware malfunction;
network malfunction; and
conditional access rights for accessing the respective said content item.

9. A method as recited in claim 1, further comprising selecting the video insertion based on one or more characteristics of a corresponding said content item.

10. A method as recited in claim 9, wherein each characteristic of a corresponding said content item is selected from a group consisting of:
genre;
content title;
actor;
author;
content category;
content owner; and
any combination of the foregoing.

11. One or more computer-readable media comprising computer-executable instructions that, when executed, perform the method as recited in claim 1.

12. A method comprising:
selecting a video insertion for inclusion in an output of an EPG by a client, wherein:
the EPG includes a plurality of cells that describe a respective plurality of content items;
a first said cell describes a first said content item that has a portion thereof that is available for output in the EPG;
a second said cell describes a second said content item that does not have a portion thereof that is available for output in the EPG; and
the video insertion is selected for output in the EPG and in conjunction with the second said cell; and
configuring the EPG for output.

13. A method as recited in claim 12, wherein the EPG references the video insertion.

14. A method as recited in claim 12, wherein the EPG includes the video insertion.

15. A method as recited in claim 12, wherein the second said content item does not have a portion thereof that is available because a conditional access right to the second said content item has not been obtained by the client.

16. A method as recited in claim 12, wherein the selecting further comprises selecting the video insertion based on one or more characteristics of the second said content item.

17. A method as recited in claim 12, wherein the selecting further comprises selecting the video insertion based on a cause of the unavailability of the second said content item.

18. One or more computer-readable media comprising computer-executable instructions that, when executed, perform the method as recited in claim 12.

19. A method comprising:
receiving an input for selecting at least one of a plurality of cells of an EPG that is output by a client, wherein each said cell describes a respective one of a plurality of content; and
when a portion of said content that corresponds to the selected cell is available to the client,
outputting the portion of said content in a segment of the EPG, and
otherwise, outputting a video insertion in the segment of the EPG.

20. A method as recited in claim 19, wherein the portion of said content is available when a conditional access right to the corresponding said content has been obtained by the client.

21. A method as recited in claim 20, wherein the conditional access right is selected from the group consisting of:
a parental block; and
purchase of the corresponding said content.

22. A method as recited in claim 19, wherein the portion of said content is selected from a group consisting of:
a trailer;
a preview;
two or more frames of said content that are edited; and
any combination of the foregoing.

23. A method as recited in claim 19, further comprising selecting the video insertion when the portion of said content is unavailable based on one or more causes for the unavailability.

24. A method as recited in claim 19, further comprising selecting the video insertion when the portion of said content is unavailable based on one or more characteristics of the corresponding said content.

25. A method as recited in claim 24, wherein each said characteristic is selected from a group consisting of:
genre;
content title;
actor;
author;
content category;
content owner; and
any combination thereof.

26. One or more computer-readable media comprising computer-executable instructions that, when executed, perform the method as recited in claim 19.

27. In a client configured for receiving content for output, wherein access to the content is controlled according to a conditional access right, a method comprising:
when the conditional access right for accessing the content has not been obtained by the client:
outputting a portion of the content; and
after the outputting of the portion of the content, outputting a video insertion that is displayable in conjunction with a function for obtaining the conditional access right.

28. A method as recited in claim 27, wherein the portion of the content is selected from a group consisting of:
a trailer;
a preview;
two or more frames that are edited from the content; and
any combination of the foregoing.

29. A method as recited in claim 27, further comprising selecting the video insertion based on one or more characteristics of the content.

30. A method as recited in claim 29, wherein each said characteristic is selected from a group consisting of:
genre;
content title;
actor;
author;
content category;
content owner; and
any combination thereof.

31. One or more computer-readable media comprising computer-executable instructions that, when executed, perform the method as recited in claim 27.

32. A client comprising:
means for interfacing with a network to receive a plurality of content items;
means for outputting; and
means for maintaining an electronic program guide (EPG) for output via the output means, the EPG having:
a plurality of means for describing a respective one said content item; and
a means for:
displaying a portion of said content when the portion is available for inclusion in the EPG; and
displaying a video insertion when the portion of said content is not available for inclusion in the EPG.

33. A client as recited in claim 32, wherein the interfacing means is configured to receive the plurality of content items when streamed over a network.

34. A client as recited in claim 32, wherein at least one said content item is a television program.

35. A client as recited in claim 32, wherein the portion is available when conditional access rights to a corresponding said content item have been obtained by the client.

36. A client as recited in claim 32, wherein the portion is selected from a group consisting of:
a trailer;
a preview;
two or more frames that are edited from the respective said content item; and
any combination thereof.

37. A client as recited in claim 32, wherein the maintaining means is further configured to include an EPG application that is executable to select the video insertion based on one or more characteristics of a corresponding said content item.

38. A client as recited in claim 32, wherein the maintaining means is further configured to include an EPG application that is executable to select the video insertion based on one or more causes for unavailability of the portion.

39. A head end comprising:
a plurality of video insertions;
EPG data describing a plurality of content: and means for:
selecting one of the plurality of video insertions for one or more content items that does not have a portion which is available for output by a client; and
generating an EPG from the EPG data for output by the client, wherein the EPG includes:
a plurality of cells, wherein each said cell describes a respective one said content item; and
a segment that is configured such that when the portion is available, the segment includes the portion when the EPG is output, and otherwise the segment includes the selected video insertion when the EPG is output.

40. A head end as recited in claim 39, wherein at least one said content item is a television program.

41. A head end as recited in claim 39, wherein the portion is available when conditional access rights to a corresponding said content item have been obtained by the client.

42. A head end as recited in claim 39, wherein the selecting means is further configured to select the video insertion based on one or more characteristics of a corresponding said content item.

43. A head end as recited in claim 39, wherein the selecting means is further configured to select the video insertion based on one or more causes for unavailability of the portion.
